(19) United States
(12) Patent Application Publication
(10) Pub. No.: US 2019/0063405 A1
(43) Pub. Date: Feb. 28, 2019

(54) VARIABLE MOMENT OF INERTIA WIND TURBINE

(71) Applicant: Adam Z. Mattmuller, Kirkland, WA (US)

(72) Inventor: Adam Z. Mattmuller, Kirkland, WA (US)

(21) Appl. No.: 15/688,876

(22) Filed: Aug. 29, 2017

(51) Int. Cl. F03D 9/12; F03D 3/00

(52) U.S. Cl. CPC F03D 9/12; F05B 2250/16; F05B 2240/60; F03D 3/005

(57) ABSTRACT

A wind turbine is modified with weights to manage variabilities in wind speed.

### FIELD

The present invention relates generally to wind power generation.

### BACKGROUND

Alternative power generation refers to the myriad of ways to generate electricity as alternatives to the use of fossil fuels. For example, wind power can be harnessed to provide electricity through the use of a wind turbine. Currently, wind turbines do not have an energy storage mechanism, which causes power generation to vary in real-time with wind speed.

FIG. 1 illustrates a common wind turbine 100 used to generate electricity. Wind turbine 100 comprises blades 10 coupled to shaft 20. Wind blowing past blades 10 transfers energy from blades 10 to shaft 20. Shaft 20 spins proportionally to the amount of wind blowing past blades 10, causing electricity to be generated in proportion to effect of wind on blades 10. When wind speed decreases, less energy is transferred to shaft 20, causing less electricity to be generated. This results in a transient in the electricity generation of common wind turbine 100.

### BRIEF DESCRIPTION OF THE FIGURES

The present invention is illustrated by way of example, and not by way of limitation, in the figures of the accompanying drawings. The novel features believed characteristic of the invention are set forth in the appended claims. The invention itself, however, as well as a preferred mode of use, further objectives, and advantages thereof, will best be understood by reference to the following detailed description of an illustrative embodiment when read in conjunction with the accompanying drawings, wherein like reference numerals indicate like components, and:

FIG. 1 is a diagram of a classical setup (prior art) for a wind turbine.

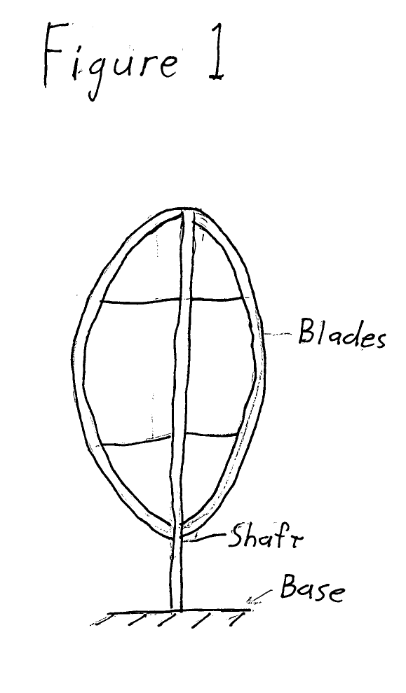

FIG. 2 is a block diagram of one embodiment of a modified wind turbine.

### DETAILED DESCRIPTION

The objective of this invention is to improve wind power generation by minimizing the effects of intermittent winds.

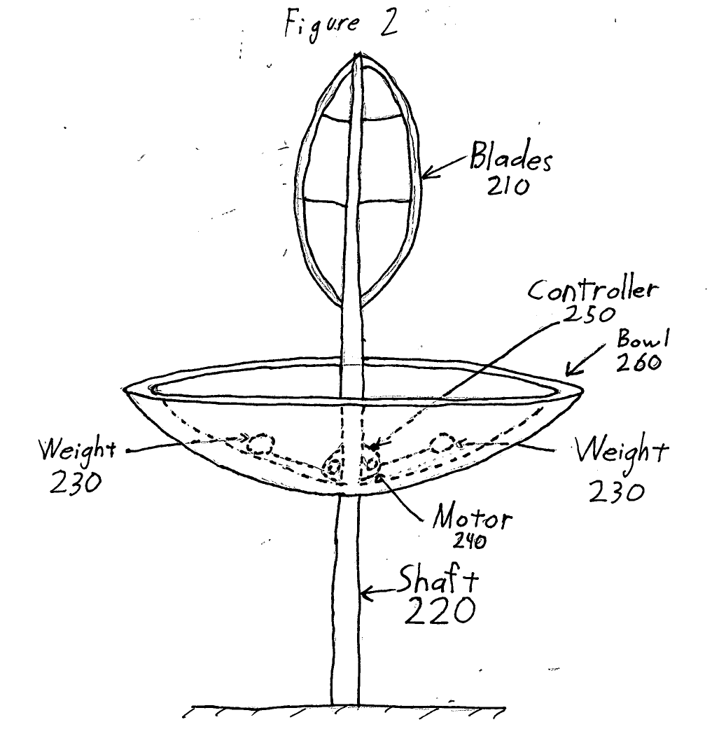

FIG. 2 is a block diagram of one embodiment of a system for generating electricity in accordance with the present invention. Wind turbine 200 comprises blades 210 coupled to shaft 220. Wind blowing past blades 210 transfers energy from blades 210 to shaft 220. Shaft 220 spins proportionally to the amount of wind blowing past blades 210, causing electricity to be generated in proportion to effect of wind on blades 210. Weights 230 coupled to shaft 220 store energy by means of kinetic and potential energy. The further out weights 230 are from shaft 220 when shaft 220 has the same rotational speed, the more energy weights 230 store. Motor 240 coupled to shaft 220 can move weights closer to and further away from shaft 220.

When wind speed decreases, less energy is transferred to shaft 220 from blades 210. However, motors may move weights 230 closer to shaft 220. Kinetic energy harnessed at this time substitutes for the energy that wind would have transferred to shaft 220 via blades 210. By moving weights inward, energy is transferred to the shaft and energy continues to be generated. This prevents a transient in the electricity generation of wind turbine 200. Similarly, when wind speed increases, motors move weights 230 further from shaft 220, increasing the kinetic energy of weights 230.

KE=(½)mv²; Equation 1:

I=mr² Equation 2:

s̅=rθ̅ Equation 3:

In one embodiment, bowl 260 is used to cancel out centrifugal force with Normal force. As weights move further towards the outside rim of bowl, they experience a higher centrifugal force directed outwards. However, the higher slope angle of the bowl further from the center creates a normal force directed inwards the center in such a way that is proportionate to the centrifugal force. With the below equation, the two forces cancel each other completely. The equation for the curve of the bowl is

$$y ( x ) = \frac{{ω}^{2}}{2 g} {x}^{2} \qquad Equation 5$$

If omega and gravity are constant from steady state to steady state in Equation 5, bowl 260 is parabolic.

In one embodiment, weight 230 is positioned to be slightly further out than the slope shown in Equation 5. This keeps tension on chain so it won't go slack. In this embodiment, a slight radius offset is added to position weight 230 correctly.

In one embodiment, an electronic governor maintains Angular Velocity at any point by adjusting electric load and keeping electricity generation proportionate to wind velocity with a constant angular velocity of the shaft in order to maintain electric frequency in normal band. If Velocity goes down, Governor will unload Demand (Load) to bring Angular Velocity up to original speed. Therefore, from steady state to steady state, angular velocity is held constant by governor. However, energy can be stored or unloaded when an offset exists between Supply and Demand. The operation is as follows: wind speed reduces, causing less energy to be transferred to rotate the shaft. The electric governor of the turbine would normally act as described above; however, as the governor unloads the electric generator and Supply reduces below Demand, causing the Controller to move weights inward. This transfers energy from the weights to the Shaft, increasing shaft angular velocity, causing Governor to increase electric load. In this manner, wind speed transients do not cause Supply to substantially differ from Demand for short transients.

The condition in which Supply is not equal to Demand may be caused by a variety of factors. Normally, Demand will follow Supply. However, controller at wind farm may wish to sell energy at higher rate at another time of day. The timescale for the strategy depends on mass, geometry, and turbine power.

The use of this mechanism will entirely depend on the size and rating. If the desire is to mitigate effects from wind gusts or lapses, a small mechanism may be used. If operator wishes to store hours worth of electricity (energy), a substantially larger mechanism is needed.

Power is another consideration. As the rate of change of mass position will directly relate to power changes (via motor and governor), power demand response can be another beneficial use of this device.

It will be appreciated by those of ordinary skill in the art that any configuration of the particular machine can be implemented as the computer system may be used according to the particular implementation.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

We claim:

1. A wind turbine comprising:
a shaft;
a bladed portion coupled to the shaft for transferring wind energy to the shaft;
a motor coupled to the shaft;
one or more weights coupled to the motor, wherein the motor moves the weights further from or closer to the shaft.

2. The wind turbine of claim 1, wherein the weights are made of a solid material.

3. The wind turbine of claim 1, wherein the weights are guided by a parabolic bowl of shape
$$y ( x ) = \frac{{ω}^{2}}{2 g} {x}^{2} .$$

4. A method for storing and releasing wind energy, the method comprising:
storing wind energy by using a motor to move weights towards the edge of a bowl; and
releasing wind energy by using a motor to move the weights towards the center of the bowl.
